(19) United States
(12) Patent Application Publication
(10) Pub. No.: US 2017/0293292 A1
(43) Pub. Date: Oct. 12, 2017

(54) RULE BASED REAL-TIME DATA STREAM-PROCESSING METHOD AND APPARATUS THEREOF

(71) Applicant: ELECTRONICS AND TELECOMMUNICATIONS RESEARCH INSTITUTE, Daejeon (KR)

(72) Inventor: Hyun-Chul KANG, Daejeon (KR)

(21) Appl. No.: 15/475,740

(22) Filed: Mar. 31, 2017

(30) Foreign Application Priority Data
Apr. 8, 2016 (KR) 10-2016-0043610

(51) Int. Cl. G05B 19/418

(52) U.S. Cl. CPC G05B 19/41885; G05B 2219/32337

(57) ABSTRACT

A method and apparatus for processing a real-time data stream. The method for processing a real-time data stream based on a rule includes selecting a rule corresponding to a current factory state with reference to a rule engine in which factory states are mapped to rules corresponding thereto, analyzing a real-time data stream to be used to control a factory resource, and, when a result of the analysis satisfies a condition defined in the rule, controlling a factory resource so as to take an action corresponding to the defined condition. According to the method, the real-time data streams collected in a factory or flowing from outside the factory are processed to be suitable for the environment in the factory, whereby the operating rate and productivity of the factory may be improved.

### CROSS REFERENCE TO RELATED APPLICATION

This application claims the benefit of Korean Patent Application No. 10-2016-0043610, filed Apr. 8, 2016, which is hereby incorporated by reference in its entirety into this application.

### BACKGROUND OF THE INVENTION

### 1. Technical Field

Embodiments of the present invention relate to a method and apparatus for processing real-time data streams.

### 2. Description of the Related Art

Global corporations that provide manufacturing solutions pursue productivity improvement through the intellectualization of processes by applying Information and Communications Technology (ICT), such as Internet of Things (IoT) technology, big data analysis technology, and the like, to manufacturing services.

Meanwhile, real-time processing of big data is newly required, but there is a lack of research for applying data processing solutions combined with IoT service to smart factory environments. In connection with this, Korean Patent No. 10-1476632 discloses a technology related to “Data processing method of real-time data analysis system and analysis coordinator thereof.”

### SUMMARY OF THE INVENTION

Embodiments of the present invention provide a method for processing a real-time data stream to be used to control factory resources.

Embodiments of the present invention provide a method for processing a real-time data stream in consideration of the state of a factory, the states of factory resources, and the like.

A method for processing a real-time data stream based on a rule according to an embodiment of the present invention includes selecting a rule corresponding to a current factory state with reference to a rule engine in which factory states are mapped to rules corresponding thereto; analyzing a real-time data stream to be used to control a factory resource; and when a result of analysis satisfies a condition defined in the rule, controlling a factory resource so as to take an action corresponding to the defined condition.

In an embodiment, the rule engine may specify information about a window size, which corresponds to each of the factory states and represents a size of a real-time data stream to be analyzed in each of the factory states.

In an embodiment, the window size may indicate a time or a number of occurrences of events.

In an embodiment, the rule engine may specify a factory resource to be used to determine each of the factory states and a critical range of the factory resource.

In an embodiment, the method may further include collecting information about the factory resource; and checking the current factory state based on the collected information about the factory resource and a critical range of a factory resource corresponding to each of the factory states, specified in the rule engine.

In an embodiment, the method may further include reselecting the rule when the current factory state is changed.

In an embodiment, selecting the rule corresponding to the current factory state may include, when multiple rules corresponding to the current factory state are specified, selecting at least one rule in consideration of a weight of each of the rules.

In an embodiment, the method may further include accumulating a result of analysis of the real-time data stream and a frequency of occurrence of each of the factory states; repeatedly changing a condition of a rule corresponding to a frequently occurring factory state and applying the accumulated result of analysis of the real-time data stream, and thereby selecting a condition under which highest utilization of a factory resource is realized; and setting the selected condition as a condition of a rule corresponding to the factory state.

In another embodiment, the method may further include accumulating a result of analysis of the real-time data stream; and setting a factory state corresponding to a frequently appearing analysis result and a rule to be used in the corresponding factory state.

An apparatus for processing a real-time data stream based on a rule according to an embodiment of the present invention includes a rule engine management unit for managing a rule engine in which factory states are mapped to rules corresponding thereto; a factory state management unit for managing a current factory state; and an information-processing unit for selecting a rule corresponding to the current factory state, analyzing a real-time data stream to be used to control a factory resource, and, when a result of analysis satisfies a condition defined in the rule, controlling the factory resource so as to take an action corresponding to the defined condition.

In an embodiment, the factory state management unit may check the current factory state based on collected information about the factory resource and a critical range of a factory resource corresponding to each of the factory states, specified in the rule engine.

In an embodiment, the information-processing unit may reselect the rule when the current factory state is changed.

In an embodiment, when multiple rules corresponding to the current factory state are specified, the information-processing unit may select at least one rule in consideration of a weight of each of the rules.

In an embodiment, the apparatus may further include an information storage unit for accumulating and managing a result of analysis of the real-time data stream and a frequency of occurrence of each of the factory states; and a simulation unit for applying the accumulated result of analysis of the real-time data stream with a change of a condition of a rule corresponding to a frequently occurring factory state, selecting a condition under which highest utilization of a factory resource is realized, and controlling the rule engine management unit so as to set the selected condition as a condition of a rule corresponding to the factory state.

In another embodiment, the apparatus may further include an information storage unit for accumulating and managing a result of analysis of the real-time data stream; and a simulation unit for controlling the rule engine management unit so as to set a factory state corresponding to a frequently appearing analysis result and a rule to be used in the corresponding factory state.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a concept diagram for explaining a method for processing a real-time data stream based on a rule according to embodiments of the present invention;

FIG. 2 is a flowchart for explaining a method for processing a real-time data stream according to an embodiment of the present invention;

FIG. 3 is an exemplary view for explaining a rule engine according to an embodiment of the present invention;

FIG. 4 is an exemplary view for explaining a rule according to an embodiment of the present invention;

FIG. 5 is a flowchart for explaining a method for optimizing a rule according to an embodiment of the present invention;

FIG. 6 is a flowchart for explaining a method for optimizing a rule according to another embodiment of the present invention; and

FIG. 7 is an exemplary view for explaining a real-time data stream-processing platform to which embodiments of the present invention are applied.

### DESCRIPTION OF THE PREFERRED EMBODIMENTS

The present invention will be described in detail below with reference to the accompanying drawings. Repeated descriptions and descriptions of known functions and configurations which have been deemed to make the gist of the present invention unnecessarily obscure will be omitted below.

Hereinafter, embodiments of the present invention will be described with reference to the accompanying drawings.

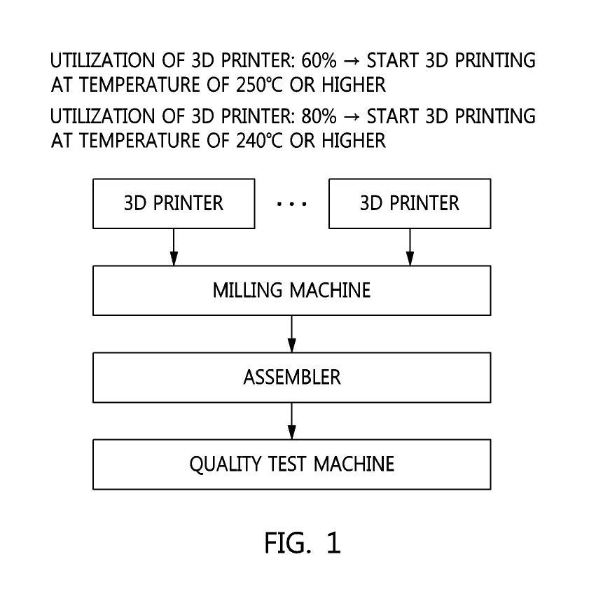

FIG. 1 is a concept diagram for explaining a method for processing a real-time data stream based on a rule according to embodiments of the present invention.

As illustrated in FIG. 1, assume that there are factory resources, such as 3D printers, a milling machine, an assembler, a quality test machine, and the like, in a factory. Here, 3D printing results output from the 3D printers sequentially pass through the milling machine, the assembler, and the quality test machine, and are then released. If the factory resources in the factory can be controlled so as to take a suitable action under appropriate conditions, the operating rate and productivity of the factory may be improved.

Meanwhile, it is necessary to consider factory states when factory resources are controlled. Here, the factory states may represent the states of a factory related to design, production, a manufacturing process history, obstacles, inventory and the like. For example, a factory state may represent the state in which a bottleneck situation or a failure has occurred in a factory resource pertaining to a certain process. The factory state may be determined depending on one or more states of factory resources. For example, the lack of inventory, which is a factory state, may be determined depending on the lack of materials for a 3D printer, which is the state of a factory resource. For example, a bottleneck situation, which is a factory state, may be determined based on the multiple states of factory resources, such as overproduction by a 3D printer and a fault in a milling machine.

Accordingly, in an embodiment of the present invention, a rule is specified for each factory state, which is determined depending on at least one factory resource state, and real-time data streams (including events) collected in a factory or flowing in from outside the factory are processed based on the current factory state and the rule corresponding thereto, whereby factory resources may be effectively managed. For example, in the factory state in which the utilization of a 3D printer is 60%, 3D printing is forced to start at temperature of 250° C. or higher, but in the factory state in which the utilization of the 3D printer is 80%, 3D printing is forced to start at temperature of 240° C. or higher, whereby the operating rate and productivity of the factory may be improved.

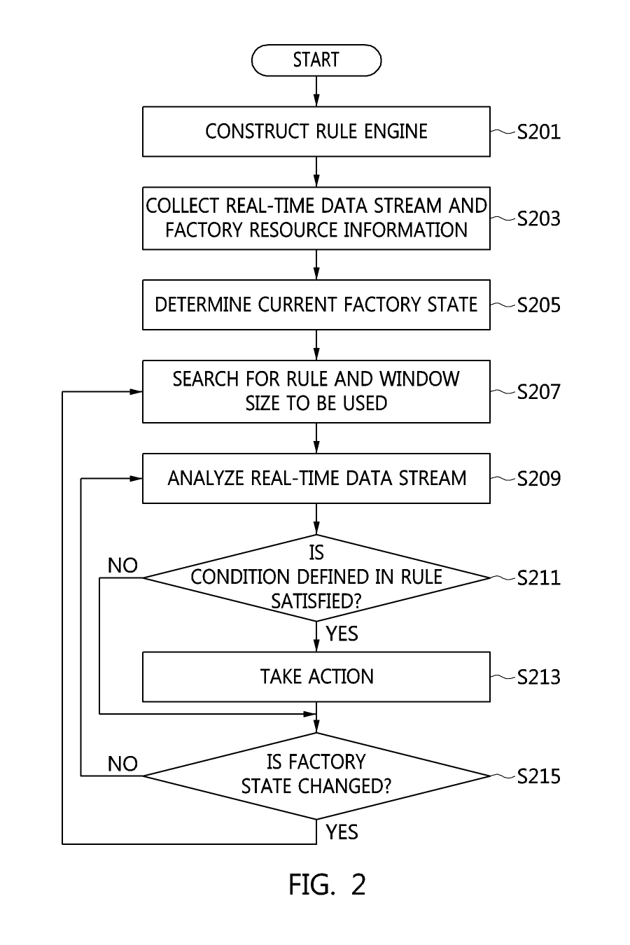

FIG. 2 is a flowchart for explaining a method for processing a real-time data stream according to an embodiment of the present invention. According to an embodiment, at least one of the steps illustrated in FIG. 2 may be skipped.

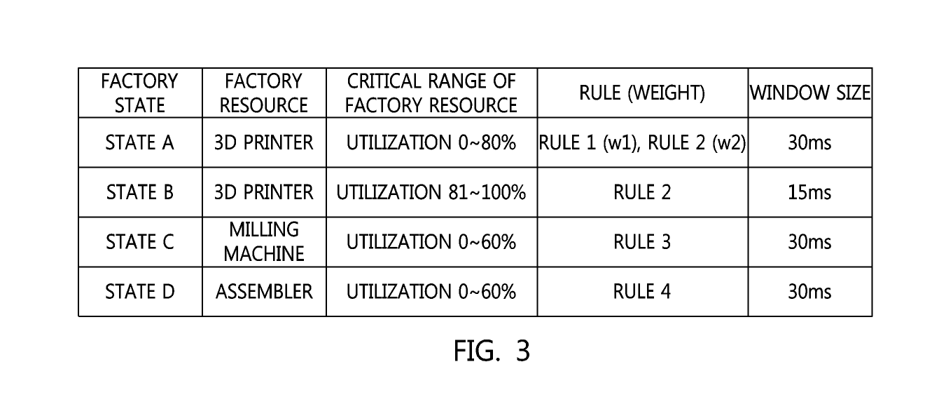

At step 201, an apparatus for processing a real-time data stream based on a rule (hereinafter, a real-time data stream-processing apparatus) may construct a rule engine to be used to process a real-time data stream in a certain factory state. In order to construct a rule engine, the real-time data stream-processing apparatus may receive rules and various kinds of information related thereto from a user. An example of the rule engine is illustrated in FIG. 3.

FIG. 3 is an exemplary view for explaining a rule engine according to an embodiment of the present invention. Referring to FIG. 3, a rule engine includes factory states and a factory resource, a critical range of the factory resource, a rule, and window size information corresponding to each of the factory states. According to an embodiment, at least one of the above-mentioned pieces of information may be omitted, or may be modified or deleted as needed. The rule engine may contain multiple rules, and may be stored in the form of a sentence in a storage device, such as memory or the like. The rules may be used for pattern recognition or situation inference.

Each of the factory states may be mapped to a factory resource and the state (the critical range) variously thereof, which are used to determine the corresponding factory state. For example, when the utilization of a 3D printer, which is a factory resource, ranges from 0 to 80%, the factory state is determined to be state A, and when the utilization of the 3D printer ranges from 81 to 100%, the factory state is determined to be state B. Because factory resources used to determine a factory state may differ, multiple factory states may be present at a certain time point. For example, a factory state at a certain time may be determined to be state A and state C.

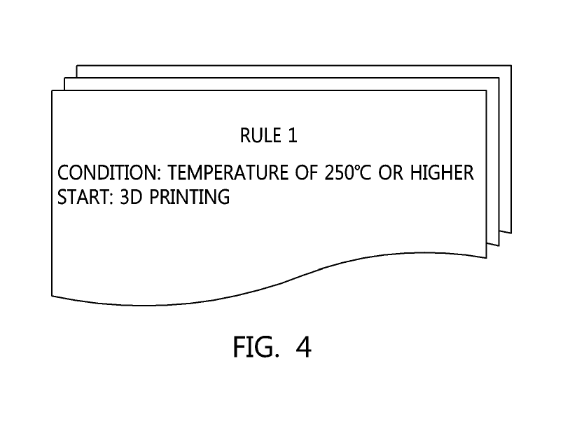

Each of the factory states may be mapped to a rule to be used in the corresponding factory state. For example, at least one of rule 1 and rule 2 may be used in state A, and rule 2 may be used in state B. When multiple rules are mapped to a single factory state, all of the multiple rules may be used in the corresponding factory state, or any one rule may be selected and used depending on the weights w1 and w2 set for the respective rules. For example, when the weight w1 for rule 1 is greater than the weight w2 for rule 2, rule 1 may be used in state A. An example of a rule is illustrated in FIG. 4.

FIG. 4 is an exemplary view for explaining a rule according to an embodiment of the present invention.

Referring to FIG. 4, a rule may include a condition and an action to be taken under the condition. A rule may be established, modified, or deleted by a user.

Referring again to FIG. 3, each of the factory states may be mapped to information about a window size, which represents the size of a real-time data stream to be analyzed in the corresponding factory state. A window size may be a time or the number of times that an event occurs. For example, if a window size of 30 ms is set for state A, a real-time data stream may be analyzed at intervals of 30 ms. In another example, if a window size is set to five events for state A, a real-time data stream may be analyzed every five times the event occurs. The window size may be set by a user.

Referring again to FIG. 2, the real-time data stream-processing apparatus may collect real-time data streams and factory resource information at step 203.

A real-time data stream is information to be used to control factory resources, and may be collected in the factory or may flow in from outside the factory. For example, the real-time data stream may include various kinds of information related to an environment in the factory or factory resources. For example, a real-time data stream may be information acquired from various types of sensors, such as vibration, pressure, movement, temperature, humidity, intensity of illuminance, a direction of wind, sound, and the like. Sensors may be installed inside or outside the factory by a user.

The factory resource information is information to be used to determine the state of factory resources, and may include various kinds of information related to design, production, a manufacturing process history, obstacles, inventory, and the like. For example, the factory resource information may include information about the operating rate of a specific factory resource, an obstacle state, and the like.

The real-time data stream and factory resource information may be collected in real time from factory resources or IoT sensors attached thereto.

At step 205, the real-time data stream-processing apparatus may determine the current factory state. The current factory state may be determined based on the rule engine and the collected factory resource information. For example, the factory resource information may be information about the utilization of a 3D printer, and the real-time data stream-processing apparatus may determine a factory state corresponding to the currently collected information about the utilization of the 3D printer by referring to the rule engine.

At step 207, the real-time data stream-processing apparatus may search for a rule and a window size to be used in the current factory state. For example, when the current factory state is determined to be state A, the real-time data stream-processing apparatus may search for a rule and a window size corresponding to state A with reference to the rule engine.

At step 209, the real-time data stream-processing apparatus may analyze the collected real-time data streams. Here, the real-time data stream-processing apparatus may analyze the real-time data stream at every window, the size of which corresponds to the current state.

At step 211, the real-time data stream-processing apparatus may determine whether the currently analyzed real-time data stream satisfies the condition defined in the rule to be used in the current state.

When the currently analyzed real-time data stream satisfies the condition defined in the rule to be used in the current state, the real-time data stream-processing apparatus may control factory resources to take the action defined in the corresponding rule at step 213. For example, when a rule to be used in the current state instructs that 3D printing starts at a temperature of 250° C. or higher and when the currently analyzed real-time data stream indicates that the temperature is equal to or higher than 250° C., the real-time data stream-processing apparatus may control the 3D printer so as to start 3D printing.

At step 215, the real-time data stream-processing apparatus may determine whether the factory state changes. For example, the real-time data stream-processing apparatus collects factory resource information and refers to the collected factory resource information and the rule engine, and may thereby determine whether the factory state has changed.

When it is determined that the factory state has not changed, the real-time data stream-processing apparatus may continue to analyze the real-time data stream based on the current factory state, determined at step 205, and the rule and window size, found at step 207.

When it is determined that the factory state changed, the real-time data stream-processing apparatus may search for a rule and a window size to be used in the changed factory state by performing step 207, and may analyze the real-time data stream based on the found rule and window size.

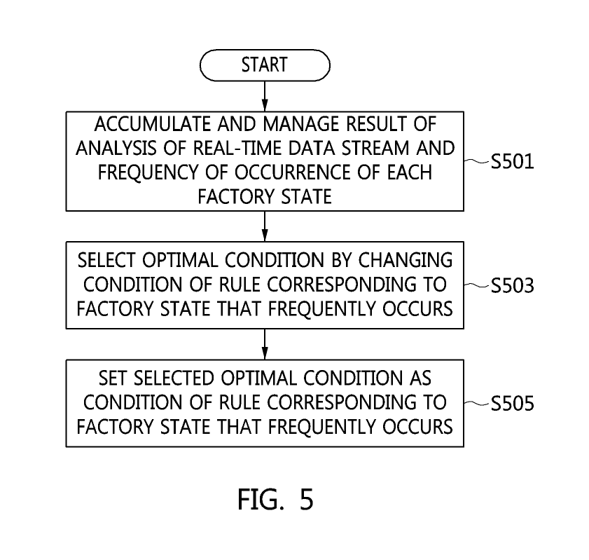

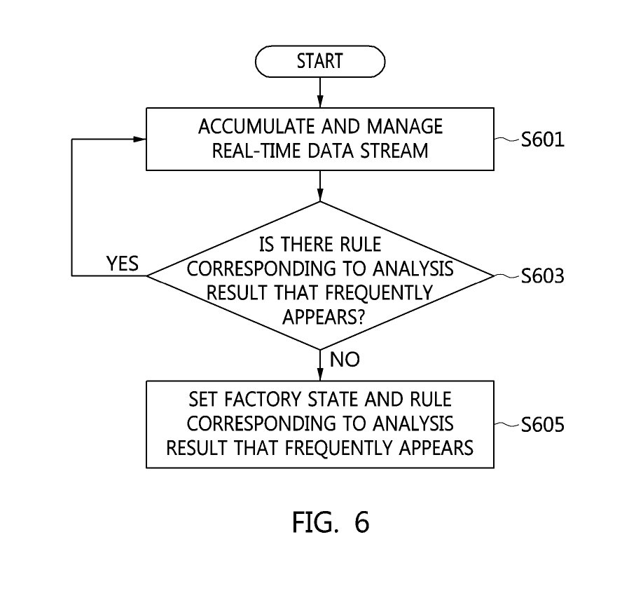

Meanwhile, the real-time data stream-processing apparatus may manage the result of analysis of the real-time data stream and information about how often each of the factory states has occurred, and may set an optimal rule by performing a simulation based on the managed information. This process will be described with reference to FIG. 5 and FIG. 6.

FIG. 5 is a flowchart for explaining a method for optimizing a rule according to an embodiment of the present invention.

At step 501, a real-time data stream-processing apparatus may accumulate the results of analysis of real-time data streams and information about the frequency of occurrence of each of the factory states, and may manage the accumulated information. For example, the real-time data stream-processing apparatus may accumulate and manage information about how many times the temperature falls within the range from 221° C. to 230° C., the range from 231° C. to 240° C., or the range from 241° C. to 250° C. and information about how many times each of the state A, B, and C has occurred.

At step 503, the real-time data stream-processing apparatus repeatedly changes the condition of the rule corresponding to the frequently occurring factory state and applies the accumulated results of analysis of the real-time data streams to the rule, thereby finding out an optimal condition under which the highest utilization of factory resources is realized. For example, if state A, which is a factory state, frequently occurs, a simulation may be repeatedly performed after changing the condition of the rule mapped to state A. For example, when the rule mapped to state A directs that 3D printing starts at temperature of 250° C. or higher, the real-time data stream-processing apparatus may change the condition of the corresponding rule to a temperature of 240° C. or higher, a temperature of 230° C. or higher, or a temperature of 220° C. or higher and perform simulations in which 3D printing starts under the changed condition. The real-time data stream-processing apparatus may select the optimal condition under which the highest utilization of factory resources is realized as the result of the simulation.

At step 505, the real-time data stream-processing apparatus may set the selected optimal condition as the condition of the rule corresponding to the factory state. For example, when it is confirmed that the highest productivity can be obtained when 3D printing starts at 220° C. in state A, the real-time data stream-processing apparatus may set or change the condition of the rule corresponding to state A to 220° C.

FIG. 6 is a flowchart for explaining a method for optimizing a rule according to another embodiment of the present invention.

At step 601, the real-time data stream-processing apparatus may accumulate the results of analysis of real-time data streams and manage the accumulated results. For example, the real-time data stream-processing apparatus may accumulate information about the number of times that the temperature falls within the range from 251° C. to 260° C., the range from 261° C. to 270° G or the range from 271° C. to 280° G and may manage the accumulated information.

At step 603, the real-time data stream-processing apparatus may check whether there is a rule corresponding to the frequently appearing analysis result. For example, when a temperature that ranges from 271° C. to 280° C. appears most frequently, the real-time data stream-processing apparatus may check whether there is a factory state corresponding to the temperature ranging from 271° C. to 280° C.

When a factory state corresponding to the frequently appearing analysis result has not been specified, the real-time data stream-processing apparatus may specify a factory state corresponding to the frequently appearing analysis result and a rule to be used in the corresponding factory state at step 605. A factory state corresponding to the frequently appearing analysis result and a rule to be used in the corresponding factory state may be input by a user. To this end, when a factory state corresponding to the frequently appearing analysis result has not been specified, the real-time data stream-processing apparatus may inform a user of this, receive a factory state and a rule to be used in the corresponding factory state from the user, and set up a rule automatically.

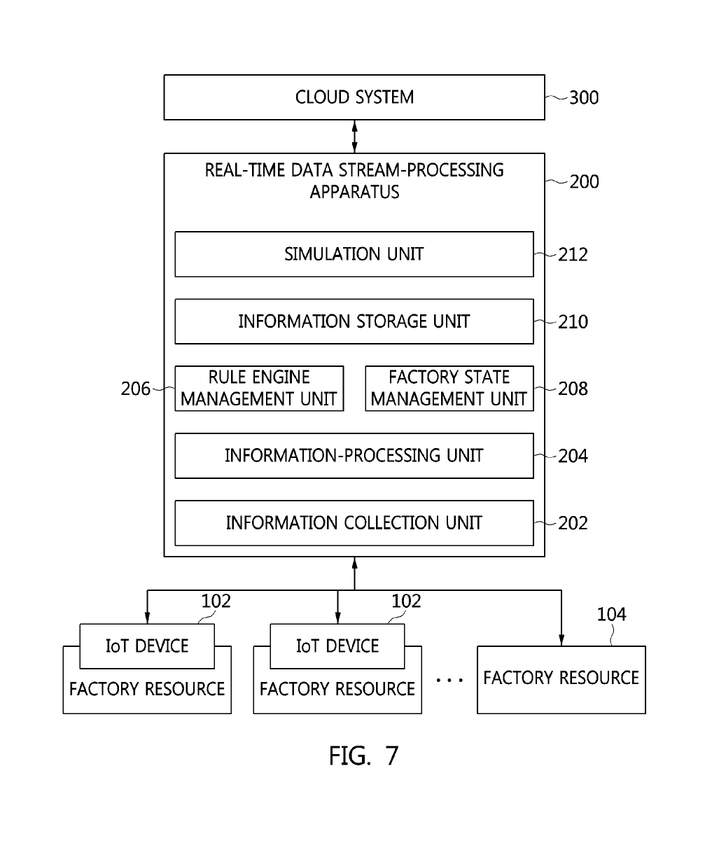

FIG. 7 is an exemplary view for explaining a real-time data stream-processing platform to which embodiments of the present invention are applied. According to an embodiment, at least one of the components illustrated in FIG. 7 may be omitted.

A real-time data stream-processing apparatus 200 includes an information collection unit 202, an information-processing unit 204, a rule engine management unit 206, a factory state management unit 208, an information storage unit 210, and a simulation unit 212.

The information collection unit 202 may collect at least one of a real-time data stream and factory resource information. The real-time data stream and the factory resource information may be collected directly from factory resources 104, or may be collected from IoT devices 102 installed in the factory resources. The factory resources may be various kinds of devices located in the factory, such as manufacturing facilities, carrier facilities, and the like. In the IoT devices 102, various types of sensors and communication modules may be installed therein, and the IoT devices 102 may sense various kinds of information.

The information-processing unit 204 may analyze a real-time data stream and factory resource information. To this end, the information-processing unit 204 may preprocess and parse the collected real-time data streams and factory resource information, and may check the validity of the information.

The information-processing unit 204 may provide the analyzed factory resource information to the factory state management unit 208, and may receive information about the current factory state from the factory state management unit 208.

The information-processing unit 204 may select a rule to be used to process the real-time data stream by referring to information about the current factory state, which is received from the factory state management unit 208. The information-processing unit 204 may analyze the real-time data stream and check whether the analyzed result satisfies the condition defined in the rule corresponding to the current factory state. If so, the information-processing unit 204 may control the factory resource so as to take an action corresponding to the condition. The information-processing unit 204 may use a pattern-filtering method when analyzing a real-time data stream.

The information-processing unit 204 may reselect a rule to be used to process a real-time data stream when a factory state is changed.

If multiple rules corresponding to the current factory state are specified, the information-processing unit 204 may select one rule or multiple rules as a rule to be used to analyze the real-time data stream in consideration of the weight of each of the multiple rules.

The rule engine management unit 206 may provide a user interface, through which a rule engine may be configured, and may receive various kinds of information for configuring the rule engine from a user. The rule engine management unit 206 may manage the configured rule engine.

The rule engine management unit 206 may modify the condition of the rule to be applied to a specific factory state depending on the result of a simulation performed by the simulation unit 212. The rule engine management unit 206 may set a factory state and a rule corresponding to a frequently appearing analysis result depending on the result of the simulation performed by the simulation unit 212. To this end, the rule engine management unit 206 may inform a user of the necessity to set a factory state and a rule corresponding to the frequently appearing analysis result.

The factory state management unit 208 may manage the current factory state. The factory state management unit 208 may check the current factory state based on information about factory resources, received from the information-processing unit 204, and a critical range of the factory resource corresponding to each of the factory states specified in the rule engine. The factory state management unit 208 may provide information about the current factory state to the information-processing unit 204 regularly, in response to the occurrence of an event, or in response to a request from the information-processing unit 204.

The information storage unit 210 may accumulate and manage at least one of the result of analysis of the real-time data stream and information about the frequency of the occurrence of a factory state. The accumulated information may be provided to the simulation unit 212.

The simulation unit 212 repeatedly changes a condition of the rule corresponding to the frequently appearing analysis result and applies the accumulated result of analysis of the real-time data stream, thereby finding the condition that enables the highest utilization of factory resources. The simulation unit 212 may control the rule engine management unit 206 so as to set the found condition as the condition of the rule corresponding to the factory state.

The simulation unit 212 checks a frequently appearing analysis result, and may then check whether a factory state corresponding thereto and a rule to be used in the corresponding factory state are specified by referring to the rule engine management unit 206. If a factory state and a rule corresponding to the frequently appearing analysis result are not specified, the simulation unit 212 may control the rule engine management unit 206 so as to specify a factory state and a rule corresponding to the frequently appearing analysis result.

Regarding a factory state and a rule corresponding to the frequently appearing analysis result, for example, it may be considered that an event generates faults in a sensor attached a specific facility at a specific time continuously. When a rule regarding the event or mapping information of the factory state does not exist, a rule may be generated or changed regarding a high frequent event according to analysis of rule-based simulation data. Specifically, if a temperature sensor attached A facility indicates over 300 degrees Celsius from 10 to 11 A.M. continuously and a vibration sensor produces a fault signal continuously, a system refers to rule set up parameters to set up a rule when any rules generated during the time do not exist. The rule set up parameters includes a rule management method, rule parameters, factory state information, action information according to rules. A rule management method means managing rules and setting a priority among rules. For example, a rule may be set up with a high priority when an event occurs from a sensor in a facility or environment information. Rule parameters may include temperature information, vibration information and facility information. In detail, rule parameters are specific parameters to set up a rule with information from sensors attached a facility. Factory state information may be defined as a specific factory state following rules. Action information according to rules may be set as whether to notify an operator of facility information, product information and sensor information according to a rule, whether to store related information in a database or whether to perform a rule which controls specific facility. (e.g. ventilator control at high temperatures) Action information may be set by a system or a user. If action information is set by a system, a confirmation or varification step regarding whether a user performs action information or not may occur after a rule is generated.

A cloud system 300 may enable a user to search for or manage various kinds of information related to factory resources by operating in conjunction with the real-time data stream-processing apparatus 200. For example, a user may check factory state information, factory resource information, and the like using the cloud system 300. The cloud system 300 may provide various user interfaces related to the order, production, distribution, or the like of products.

The above-described embodiments of the present invention may be implemented using various methods. For example, embodiments of the present invention may be implemented using hardware, software, or a combination thereof. When implemented in software, embodiments may be implemented in software executed on one or more processors using various operating systems or platforms. Additionally, such software may be written using any one of multiple suitable programming languages, and may be compiled to machine code or intermediate code executable in a framework or a virtual machine.

Also, when embodiments of the present invention are executed on one or more processors, they may be implemented in the form of a processor-readable medium (for example, memory, a floppy disk, a hard disk, a compact disk, an optical disk, a magnetic tape, or the like) in which one or more programs for performing a method for implementing the various embodiments of the present invention, which have been described above, are recorded.

According to embodiments of the present invention, real-time data streams collected in a factory or flowing in from outside the factory may be processed so as to suit the environment of the factory, whereby the utilization and productivity of the factory may be improved.

According to embodiments of the present invention, the efficiency of production, processes, and operations at a factory may be improved.

What is claimed is:

1. A method for processing a real-time data stream based on a rule, comprising:
selecting a rule corresponding to a current factory state with reference to a rule engine in which factory states are mapped to rules corresponding thereto;
analyzing a real-time data stream to be used to control a factory resource; and
when a result of analysis satisfies a condition defined in the rule, controlling a factory resource so as to take an action corresponding to the defined condition.

2. The method of claim 1, wherein the rule engine specifies information about a window size, which corresponds to each of the factory states and represents a size of a real-time data stream to be analyzed in each of the factory states.

3. The method of claim 1, wherein the window size indicates a time or a number of occurrences of events.

4. The method of claim 1, wherein the rule engine specifies a factory resource to be used to determine each of the factory states and a critical range of the factory resource.

5. The method of claim 4, further comprising:
collecting information about the factory resource; and
checking the current factory state based on the collected information about the factory resource and a critical range of a factory resource corresponding to each of the factory states, specified in the rule engine.

6. The method of claim 1, further comprising:
reselecting the rule when the current factory state is changed.

7. The method of claim 1, wherein selecting the rule corresponding to the current factory state comprises:
when multiple rules corresponding to the current factory state are specified, selecting at least one rule in consideration of a weight of each of the rules.

8. The method of claim 1, further comprising:
accumulating a result of analysis of the real-time data stream and a frequency of occurrence of each of the factory states;
repeatedly changing a condition of a rule corresponding to a frequently occurring factory state and applying the accumulated result of analysis of the real-time data stream, and thereby selecting a condition under which highest utilization of a factory resource is realized; and
setting the selected condition as a condition of a rule corresponding to the factory state.

9. The method of claim 1, further comprising:
accumulating a result of analysis of the real-time data stream; and
setting a factory state corresponding to a frequently appearing analysis result and a rule to be used in the corresponding factory state.

10. An apparatus for processing a real-time data stream based on a rule, comprising:
a rule engine management unit for managing a rule engine in which factory states are mapped to rules corresponding thereto;
a factory state management unit for managing a current factory state; and
an information-processing unit for selecting a rule corresponding to the current factory state, analyzing a real-time data stream to be used to control a factory resource, and, when a result of analysis satisfies a condition defined in the rule, controlling the factory resource so as to take an action corresponding to the defined condition.

11. The apparatus of claim 10, wherein the rule engine specifies information about a window size, which corresponds to each of the factory states and represents a size of a real-time data stream to be analyzed in each of the factory states.

12. The apparatus of claim 10, wherein the window size indicates a time or a number of occurrences of events.

13. The apparatus of claim 10, wherein the rule engine specifies a factory resource to be used to determine each of the factory states and a critical range of the corresponding factory resource.

14. The apparatus of claim 13, wherein the factory state management unit checks the current factory state based on collected information about the factory resource and a critical range of a factory resource corresponding to each of the factory states, specified in the rule engine.

15. The apparatus of claim 10, wherein the information-processing unit reselects the rule when the current factory state is changed.

16. The apparatus of claim 10, wherein, when multiple rules corresponding to the current factory state are specified, the information-processing unit selects at least one rule in consideration of a weight of each of the rules.

17. The apparatus of claim 10, further comprising:
an information storage unit for accumulating and managing a result of analysis of the real-time data stream and a frequency of occurrence of each of the factory states; and
a simulation unit for applying the accumulated result of analysis of the real-time data stream with a change of a condition of a rule corresponding to a frequently occurring factory state, selecting a condition under which highest utilization of a factory resource is realized, and controlling the rule engine management unit so as to set the selected condition as a condition of a rule corresponding to the factory state.

18. The apparatus of claim 10, further comprising:
an information storage unit for accumulating and managing a result of analysis of the real-time data stream; and
a simulation unit for controlling the rule engine management unit so as to set a factory state corresponding to a frequently appearing analysis result and a rule to be used in the corresponding factory state.
